(19) United States
(12) Patent Application Publication
(10) Pub. No.: US 2021/0062728 A1
(43) Pub. Date: Mar. 4, 2021

(54) Actuation Assembly for Concentric Variable Stator Vanes

(71) Applicant: General Electric Company, Schenectady, NY (US)

(72) Inventors: Mark Frisch, Mason, OH (US); Mark Joseph Mielke, Blanchester, OH (US); Thomas Lee Becker, Symmes Township, OH (US)

(21) Appl. No.: 16/560,089

(22) Filed: Sep. 4, 2019

(51) Int. Cl. F02C 9/22; F01D 9/02

(52) U.S. Cl. CPC F02C 9/22; F05D 2220/32; F01D 9/02

(57) ABSTRACT

An actuation assembly for concentric variable stator vanes of a rotary component of a gas turbine engine. The actuation assembly includes an inner casing and an intermediate casing defining a first concentric flowpath extending between the inner casing and the intermediate casing. The actuation assembly includes an outer casing defining a second concentric flowpath extending between the intermediate casing and the outer casing. The actuation assembly includes a first variable stator vane extending radially inward from the intermediate casing into the first concentric flowpath. The actuation assembly includes a second variable stator vane extending radially within the second concentric flowpath between a distal end at the outer casing and proximate end at the inner casing and defining a cavity extending therebetween. A first trunnion extends radially inward from the outer casing through the cavity of the second variable stator vane and is drivingly coupled to the first variable stator vane.

### FEDERALLY SPONSORED RESEARCH

This invention was made with government support. The government may have certain rights in the invention.

### FIELD

The present subject matter relates generally to variable stator vanes for gas turbine engines, more particularly, to variable stator vanes for concentric flowpaths of gas turbine engines.

### BACKGROUND

A gas turbine engine generally includes a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere. Turbofan gas turbine engines typically include a fan assembly that channels air to the core gas turbine engine, such as an inlet to the compressor section, and to a bypass duct. Gas turbine engines, such as turbofans, generally include fan cases surrounding the fan assembly including the fan blades. The compressor section typically includes one or more compressors with corresponding compressor casings. Additionally, the turbine section typically includes one or more turbines with corresponding turbine casings.

Rotary components of the gas turbine engine, such as any compressors or turbines of the gas turbine engine, may include both rotating and stationary components. Generally, a shaft drives a central rotor drum or wheel, which has a number of annular rotors. Rotor stages of the component rotate between a similar number of stationary stator stages, with each rotor stage including a plurality of rotor blades secured to the rotor wheel and each stator stage including a plurality of stator vanes secured to an outer casing of the rotary component. During operation, airflow passes through the compressor stages and is sequentially compressed, with each succeeding downstream stage increasing the pressure until the air is discharged from the compressor outlet at a maximum pressure. Subsequently, the compressed airflow passes to the turbine stages after combustion in the combustion section. Further, each of the turbine stages extracts energy from the combustion gases to drive rotation of the compressor section and fan section of the gas turbine engine before the combustion gases are routed to the exhaust section to provide propulsion to the gas turbine engine.

In order to improve the performance of a rotary component, one or more of the stator stages may include variable stator vanes configured to be rotated about their longitudinal or radial axes. Such variable stator vanes generally permit increased efficiency and operability to be enhanced by controlling the amount of air flowing into and through the rotary component by rotating the angle at which the stator vanes are oriented relative to the flow of air. Rotation of the variable stator vanes is generally accomplished by attaching a lever arm to each stator vane and joining each of the levers to a unison or synchronizing a ring disposed substantially concentric with respect to the rotor casing positioned radially outward from the variable stator vanes. The synchronizing ring, in turn, is coupled to an actuator configured to rotate the ring about the central axis of the rotary component. As the synchronizing ring is rotated by the actuator, the lever arms are correspondingly rotated, thereby causing each stator vane to rotate about its radial or longitudinal axis.

Certain gas turbine engines may include multiple concentric flowpaths for the airflow or combustion products through the gas turbine engine. Generally, such concentric flowpaths may be radially oriented with respect to one another. Further, the concentric flowpaths may each include variable stator vanes, rotor blades, or both. However, it may generally be difficult to rotate the variable stator vanes within an inner concentric flowpath from lever arms positioned radially outward from the rotor casing of an outer concentric flowpath of the gas turbine engine.

As such, a need exists for an improved actuation assembly for adjusting variable stator vanes of concentric flowpaths of a gas turbine engine.

### BRIEF DESCRIPTION

Aspects and advantages will be set forth in part in the following description, or may be obvious from the description, or may be learned through practice of the invention.

In one aspect, the present subject matter is directed to an actuation assembly for concentric variable stator vanes of a rotary component of a gas turbine engine. The gas turbine engine defines a central axis extending along an axial direction. The actuation assembly includes an inner casing and an intermediate casing. The inner casing and intermediate casing define a first concentric flowpath extending along the axial direction between the inner casing and the intermediate casing. The actuation assembly further includes an outer casing. The intermediate casing and outer casing define a second concentric flowpath extending along the axial direction between the intermediate casing and the outer casing. Additionally, the second concentric flowpath is positioned radially exterior to the first concentric flowpath. The actuation assembly includes a first variable stator vane extending radially inward from the intermediate casing into the first concentric flowpath. Further, the actuation assembly includes a second variable stator vane extending radially within the second concentric flowpath between a distal end at the outer casing and proximate end at the inner casing. Moreover, the second variable stator vane defines a cavity extending between the distal end and the proximate end. The actuation assembly also includes a first trunnion extending radially inward from the outer casing through the cavity of the second variable stator vane and drivingly coupled to the first variable stator vane.

In one embodiment, an orientation of the first variable stator vane and an orientation of the second variable stator vane may be independently adjustable. In another embodiment, the first and second variable stator vanes may be radially aligned. In a further embodiment, the actuation assembly may further include a first rotational device positioned at the outer casing and drivingly coupled to the first trunnion such that rotation of the first rotational device alters an orientation of the first variable stator vane. In another embodiment, the actuation assembly may further include a second trunnion extending radially inward from the outer casing and drivingly coupled to the second variable stator vane. Moreover, the second trunnion may define a bore extending radially through the second trunnion such that the first trunnion extends through the bore of the second trunnion to the first variable stator vane. In one such embodiment, the actuation assembly may further include a bushing positioned between the first trunnion and the second trunnion. In another such embodiment, the actuation assembly may further include a second rotational device positioned at the outer casing and drivingly coupled to the second trunnion such that rotation of the second rotational device alters an orientation of the second variable stator vane.

In another embodiment, the first and second variable stator vanes may each define an aerodynamic profile including a leading edge, trailing edge, pressure side, and suction side. In one embodiment, at least one of the first variable stator vane or the second variable stator vane may be a compressor vane. In a further embodiment, at least one of the first variable stator vane or the second variable stator vane may be a turbine vane. In a further embodiment, one or more of the first variable stator vane or the second variable stator vane may be configured to act as a valve.

In another aspect, the present subject matter is directed to a rotary component for a gas turbine engine defining a central axis extending along an axial direction. The rotary component includes an inner casing and an intermediate casing. The inner casing and intermediate casing define a first concentric flowpath extending along the axial direction between the inner casing and the intermediate casing. The rotary component additionally includes an outer casing. The intermediate casing and outer casing define a second concentric flowpath extending along the axial direction between the intermediate casing and the outer casing. Additionally, the second concentric flowpath is positioned radially exterior to the first concentric flowpath. The rotary component further includes a plurality of rotor blades circumferentially oriented within the first concentric flowpath and drivingly coupled to a rotor extending along the central axis. Moreover, the plurality of rotor blades extends radially outward from the rotor to the intermediate casing within the first concentric flowpath. The rotary component further includes a plurality of first variable stator vanes circumferentially oriented within the first concentric flowpath and extending radially inward from the intermediate casing into the first concentric flowpath. Additionally, the plurality of rotor blades and the plurality of first variable stator vanes form a stage of the rotary component. The rotary component further includes a plurality of second variable stator vanes circumferentially oriented within the second concentric flowpath. Each of the second variable stator vanes extends radially within the second concentric flowpath between a distal end at the outer casing and proximate end at the intermediate casing and defines a cavity extending between the distal end and the proximate end. The rotary component also includes a plurality of first trunnions. Each of the first trunnions extends radially inward from the outer casing through the cavity of one of the plurality of second variable stator vanes and is drivingly coupled to one of the plurality of first variable stator vanes.

In one embodiment, the rotary component may be a compressor. In such an embodiment, each of the plurality of rotor blades may be a compressor blade, and each of the plurality of first variable stator vanes may be a compressor vane. In another embodiment, the rotary component may be a turbine. In such an embodiment, each of the plurality of rotor blades may be a turbine blade, and each of the plurality of first variable stator vanes is a turbine vane. In a further embodiment, each of the plurality of rotor blades extends radially outward from the rotor to the outer casing and includes a platform separating the first concentric flowpath from the second concentric flowpath. Additionally, each of the rotor blades includes a first airfoil portion within the first concentric flowpath and a second airfoil portion within the second concentric flowpath. It should be further understood that the rotary component may further include any of the additional features as described herein.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended FIGS., in which:

FIG. 1 illustrates a cross-sectional view of one embodiment of a gas turbine engine that may be utilized within an aircraft in accordance with aspects of the present subject matter, particularly illustrating the gas turbine engine configured as a high-bypass turbofan jet engine;

FIG. 2 illustrates a schematic view of one embodiment of a rotary component of the gas turbine engine of FIG. 1 in accordance with aspects of the present subject matter, particularly illustrating a rotary component including multiple concentric flowpaths.

FIG. 3 illustrates a schematic drawing of one embodiment of an actuation assembly of FIG. 2 in accordance with aspects of the present subject matter, particularly illustrating a side view of the actuation assembly;

FIG. 4 illustrates a cross-section of the actuation assembly along section line 4-4 of FIG. 3 in accordance with aspects of the present subject matter, particularly illustrating trunnions of the actuation assembly; and

FIG. 5 illustrates one embodiment of a rotational device in accordance with aspects of the present disclosure, particularly illustrating the rotational device configured to alter the orientation of multiple stator vanes of the rotary component.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The terms “communicate,” “communicating,” “communicative,” and the like refer to both direct communication as well as indirect communication such as through a memory system or another intermediary system.

An actuation assembly for a gas turbine engine is generally provided for use with variable stator vanes concentrically oriented within a rotary component of the gas turbine engine. For instance, the actuation assembly may generally be utilized in concentric flowpaths of a compressor, turbine, fan section, or any combination of the preceding of the gas turbine engine. More particularly, inner variable stator vanes may positioned within an inner flowpath between an inner casing an intermediate casing. Additionally, outer variable stator vanes may be positioned radially exterior to inner stator vanes within an outer flowpath between the intermediate casing and an outer casing. The stator vanes may extend generally radially within the inner and outer flowpaths. Additionally, the outer stator vane may define a cavity extending between the outer casing and the inner casing. As such, the actuation assembly may include an inner trunnion extending radially within the cavity of the outer stator vane and drivingly coupled to the inner stator vane. As such, rotation of the inner trunnion from the outer casing may adjust an orientation of the inner stator vane. In various embodiments, the actuation assembly may include an outer trunnion extending radially inward from the outer casing and drivingly coupled to the outer stator vane. As such, rotating the outer trunnion from the outer casing may adjust an orientation of the outer stator vane. Moreover, the outer trunnion may define a bore extending radially through the outer trunnion such that the inner trunnion extends through the bore of the outer trunnion to adjust the inner stator vane. It should be recognized that trunnions in such a nested arrangement may allow the orientation of the inner stator vanes to be adjusted without requiring struts within the outer flowpath surrounding the inner trunnion. As such, embodiments of the present actuation assembly may reduce the weight of the rotary component and thus increase the efficiency of the gas turbine engine. Additionally, such an actuation assembly may allow for a desirable aerodynamic profile surrounding the inner trunnions within the outer flowpath and also increase the efficiency of the gas turbine engine.

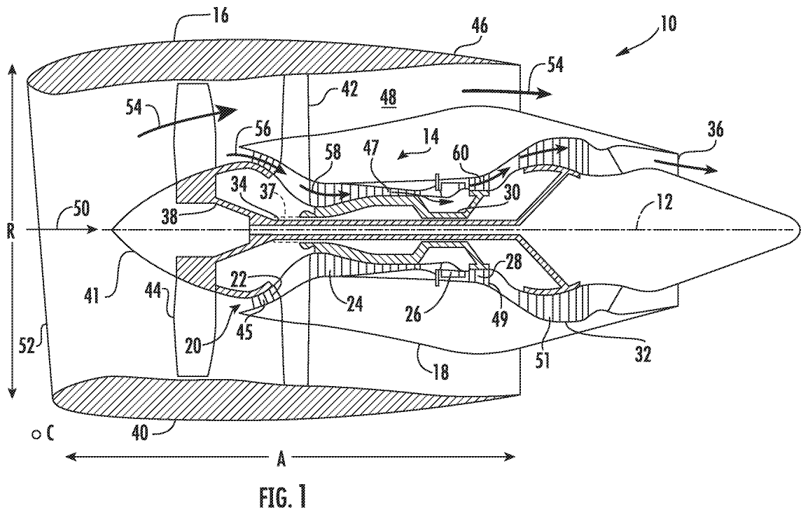

Referring now to the drawings, FIG. 1 illustrates a cross-sectional view of one embodiment of a gas turbine engine 10 that may be utilized within an aircraft in accordance with aspects of the present subject matter. More particularly, for the embodiment of FIG. 1, the gas turbine engine 10 is a high-bypass turbofan jet engine, with the gas turbine engine 10 being shown having a longitudinal or axial centerline axis 12 extending therethrough along an axial direction A for reference purposes. The gas turbine engine 10 further defines a radial direction R extending perpendicular from the central axis 12. Further, a circumferential direction C (shown in/out of the page in FIG. 1) extends perpendicular to both the central axis 12 and the radial direction R. Although an exemplary turbofan embodiment is shown, it is anticipated that the present disclosure can be equally applicable to turbomachinery in general, such as an open rotor, a turboshaft, turbojet, or a turboprop configuration, including marine and industrial turbine engines and auxiliary power units.

In general, the gas turbine engine 10 includes a core gas turbine engine (indicated generally by reference character 14) and a fan section 16 positioned upstream thereof. The core engine 14 generally includes a substantially tubular outer casing 18 that defines an annular inlet 20. In addition, the outer casing 18 may further enclose and support a low pressure (LP) compressor 22 for increasing the pressure of the air that enters the core engine 14 to a first pressure level. A multi-stage, axial-flow high pressure (HP) compressor 24 may then receive the pressurized air from the LP compressor 22 and further increase the pressure of such air. The pressurized air exiting the HP compressor 24 may then flow to a combustor 26 within which fuel is injected into the flow of pressurized air, with the resulting mixture being combusted within the combustor 26. The high energy combustion products 60 are directed from the combustor 26 along the hot gas path of the gas turbine engine 10 to a high pressure (HP) turbine 28 for driving the HP compressor 24 via a high pressure (HP) shaft or spool 30, and then to a low pressure (LP) turbine 32 for driving the LP compressor 22 and fan section 16 via a low pressure (LP) drive shaft or spool 34 that is generally coaxial with HP shaft 30. After driving each of turbines 28 and 32, the combustion products 60 may be expelled from the core engine 14 via an exhaust nozzle 36 to provide propulsive jet thrust.

Additionally, as shown in FIG. 1, the fan section 16 of the gas turbine engine 10 generally includes a rotatable, axial-flow fan rotor 38 configured to be surrounded by an annular fan casing 40. In particular embodiments, the LP shaft 34 may be connected directly to the fan rotor 38 or a rotor disk, such as in a direct-drive configuration. In alternative configurations, the LP shaft 34 may be connected to the fan rotor 38 via a speed reduction device 37 such as a reduction gear gearbox in an indirect-drive or geared-drive configuration. Such speed reduction devices may be included between any suitable shafts/spools within the gas turbine engine 10 as desired or required. Additionally, the fan rotor 38 and/or rotor disk may be enclosed or formed as part of a fan hub 41.

It should be appreciated by those of ordinary skill in the art that the fan casing 40 may be configured to be supported relative to the core engine 14 by a plurality of substantially radially-extending, circumferentially-spaced outlet guide vanes 42. As such, the fan casing 40 may enclose the fan rotor 38 and its corresponding fan rotor blades (fan blades 44). Moreover, a downstream section 46 of the fan casing 40 may extend over an outer portion of the core engine 14 so as to define a secondary, or by-pass, airflow conduit 48 that provides additional propulsive jet thrust.

During operation of the gas turbine engine 10, it should be appreciated that an initial airflow (indicated by arrow 50) may enter the gas turbine engine 10 through an associated inlet 52 of the fan casing 40. The air flow 50 then passes through the fan blades 44 and splits into a first compressed air flow (indicated by arrow 54) that moves through the by-pass conduit 48 and a second compressed air flow (indicated by arrow 56) which enters the LP compressor 22. The LP compressor 22 may include a plurality of compressor rotor blades (LP compressor blades 45) enclosed by the outer casing 18. The pressure of the second compressed air flow 56 is then increased and enters the HP compressor 24 (as indicated by arrow 58). Additionally, the HP compressor 24 may include a plurality of compressor rotor blades (HP compressor blades 47) enclosed by the outer casing 18. After mixing with fuel and being combusted within the combustor 26, the combustion products 60 exit the combustor 26 and flow through the HP turbine 28. Further, the HP turbine 28 may include a plurality of turbine rotor blades (HP turbine blades 49). Thereafter, the combustion products 60 flow through the LP turbine 32 and exit the exhaust nozzle 36 to provide thrust for the gas turbine engine 10. Furthermore, the LP turbine 32 may include a plurality of turbine rotor blades (LP turbine blades 51).

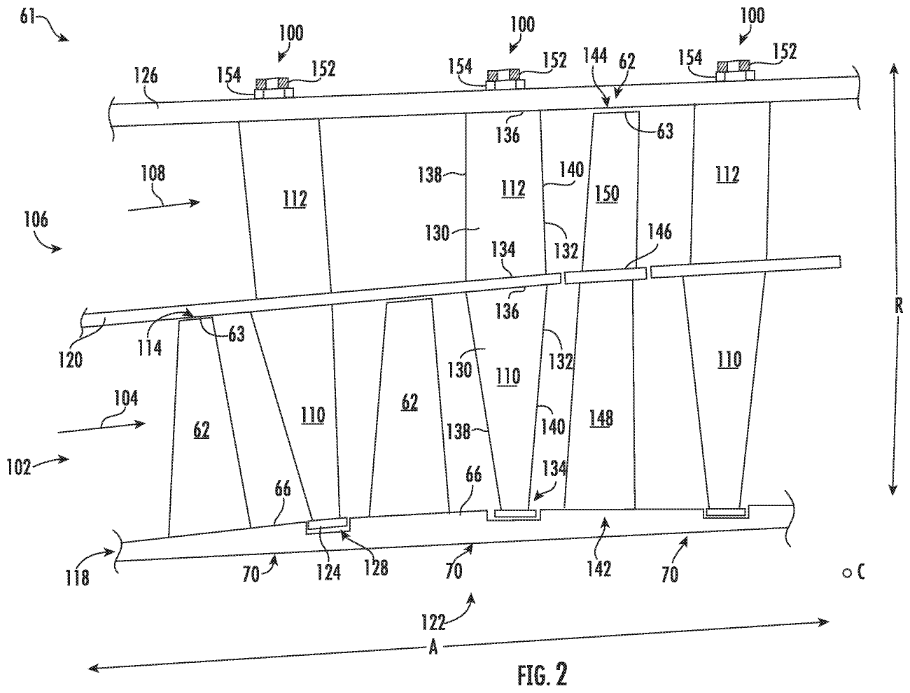

Referring now to FIG. 2, illustrated schematically is one embodiment of a rotary component 61 of the gas turbine engine 10. Particularly, FIG. 2 illustrates a rotary component 61 defining multiple concentric flowpaths. As illustrated, the rotary component 61 may define a first concentric flowpath (inner flowpath 102) for an inner fluid flow 104. The rotary component may further define a second concentric flowpath (outer flowpath 106) for an outer fluid flow 108. As depicted, the outer flowpath 106 may be positioned radially exterior to the inner flowpath 102. The rotary component 61 may include one or more first variable stator vanes (inner stator vanes 110) arranged within the inner flowpath 102. The rotary component 61 may further include one or more second variable stator vanes (outer stator vanes 112) arranged within the outer flowpath 106. Additionally, each of the outer stator vanes 112 may be radially aligned with one of the inner stator vanes 110.

The rotary component 61 may further include one or more actuation assemblies 100 for each pair of concentric variable stator vanes 110, 112 configured to alter an orientation of the stator vanes 110, 112. More particularly, the actuation assembl(ies) 100 may allow for an orientation of the inner stator vane(s) 110 to be adjusted independently from an orientation of the outer stator vane(s) 112. Furthermore, adjusting the orientation of the inner stator van(s) 110 and/or the outer stator vane(s) 112 may allow for the adjustment of the inner fluid flow 104 within the inner flowpath 102 and/or the outer fluid flow 108 within the outer flowpath 106, respectively. As such, it should be appreciated that the stator vanes(s) 110, 112 may act as valve(s) to control the fluid flow 104, 108 within the flowpaths 102, 106. Although the rotary component 61 is described as a component of the gas turbine engine 10, it should be recognized that the rotary component 61 may be utilized in any suitable configuration of a gas turbine engine. For instance, the rotary component 61 may be configured as a portion of one or more of the LP compressor 22, the HP compressor 24, the fan section 16, the HP turbine 28, the LP turbine 32, and/or any other rotary component 61 of the gas turbine engine 10.

As depicted in FIG. 2, the inner flowpath 102 is defined between the inner casing 118 and an intermediate casing 120 and extend generally in the axial direction A between the inner and intermediate casings 118, 120. It should be appreciated that the intermediate casing 120 may be a stationary component of the gas turbine engine 10. Further, the inner casing 118 may include a combination of stationary and rotating components. For instance, as illustrated in FIG. 2, the inner casing 118 may include a hub 66 of a rotor 122 and/or one or more platforms 124 at a radially inner portion of the inner stator vane(s) 110. Additionally, the rotary component 61 may include an outer casing 126 defining the outer flowpath 106 extending in the axial direction A between the intermediate casing 120 and the outer casing 126.

For instance, in one embodiment, the intermediate casing 120 of the rotary component 61 may include at least a part of the outer casing 18 of the core engine 14, and the outer casing 126 of the rotary component 61 may be a part of the fan casing 40 of the gas turbine engine 10. For instance, the intermediate casing 120 may include a compressor casing or turbine casing or a standalone component coupled thereto. In such an embodiment, the inner flowpath 102 may include the flowpath through the core engine 14. As such, the inner fluid flow 104 may include one or more of the second compressed air flow 56, the airflow 58, or the combustion products 60. Moreover, the outer flowpath 106 may include the by-pass conduit 48, and the outer fluid flow 108 may include the first compressed airflow 54.

In another embodiment, the outer casing 126 of the rotary component 61 may include at least a part of the outer casing 18 of the core engine 14. For instance, the outer casing 126 may include a compressor casing, turbine casing, the fan casing 40 (e.g., a fan containment casing) or a standalone component coupled thereto. Moreover, the intermediate casing 120 may be a casing arranged between the outer casing 126 and the inner casing 118 of the rotary component 61 in order to define the inner flowpath 102 and the outer flowpath 106. As such, at least one of the second compressed air flow 56, the airflow 58, or the combustion products 60 flowing through the core engine 14 may be split into the inner fluid flow 104 and outer fluid flow 108 upstream of the rotary component 61.

The rotary component 61 may include one or more sets of circumferentially oriented rotor blades 62 within the inner flowpath 102, such as the fan blades 44, LP compressor blades 45, HP compressor blades 47, HP turbine blades 49, or LP turbine blades 51, which extend radially outwards towards the intermediate casing 120 from a rotor 122 or from the hub 66 attached to or formed integrally with the rotor 122 within the inner flowpath 102. As such, the rotor blades 62 may be drivingly coupled to the rotor 122 which may include or be drivingly coupled to a rotating shaft (such as the HP shaft 30 or LP shaft 34 as shown in FIG. 1). Further, the intermediate casing 120 may be arranged exterior to the rotor blades 62 in the radial direction R. One or more of the rotor blades 62, such as all of the rotor blades 62, may be circumscribed by the intermediate casing 120 such that an annular gap 114 is defined between the intermediate casing 120 and a rotor blade tip 63 of each rotor blade 62. It should be appreciated that one or more of the rotor blades 62 may be compressor blades 45, 47; turbine blades 49, 51; or fan blades 44 of a compressor 22, 24; turbine 28, 32; or fan section 16, respectively.

In one embodiment, one or more of the rotor blades 62 be a platformed rotor blade 142 (one of which is shown in FIG. 2) extending within both the inner flowpath 102 and the outer flowpath 106. For instance, each of the rotor blades 62 may be a platformed rotor blade 142. As shown, the platformed rotor blade 142 may extend radially outward from the rotor 122 and/or hub 66, through the intermediate casing 120 to the outer casing 126. It should be appreciated that the platformed rotor blade 142 and outer casing 126 may define an annular gap 144 between a tip 63 of the platformed rotor blade 142 and the outer casing 126 in order to allow relative rotation therebetween. Further, the platformed rotor blade 142 may include a platform 146 radially and axially aligned with the intermediate casing 120 in order to separate the inner flowpath 102 from the outer flowpath 106. As such, the platformed rotor blade 142 may include a first airfoil portion 148 within the inner flowpath 102 and a second airfoil portion 150 within the outer flowpath 106.

One or more sets of the circumferentially-spaced inner stator vanes 110 may be positioned adjacent to each set of rotor blades 62, and in combination form one of a plurality of stages 70 with the adjacent set of rotor blades 62. For instance, the inner stator vanes 110 may extend radially inward from the intermediate casing 120 into the inner flowpath 102 and terminate at an inner platform 124 adjacent to the hub 66 and/or rotor 122. Additionally, the inner stator vanes 110 may be disposed relative to the hub 66, such that an annular gap 128 is defined between the hub 66 and the inner platform 124 of each of the inner stator vane 110. As such, the inner stator vanes 110 of each stage 70 may be circumferentially oriented within the inner flowpath 102.

Still referring to the exemplary embodiment of FIG. 2, one or more outer stator vanes 112 may extend radially within the outer flowpath 106. For instance, the outer stator vanes 112 may extend radially between the outer casing 126 and the intermediate casing 120. Additionally, two or more outer stator vanes 112 may be arranged circumferentially within the outer flowpath 106. As shown, the inner and outer stator vanes 110, 112 may be radially aligned in pairs within the rotary component 61. It should be appreciated that one or more of the inner and outer stator vanes 110, 112 may define an aerodynamic profile. For instance, each of the inner and outer stator vanes 110, 112 may include a pressure side 130 and suction side 132 extending radially between a root 134 and a tip 136. Further, the pressure side 130 and suction side 132 of each of the vanes 110, 112 may extend between a forward leading edge 138 and an aft trailing edge 140. In several embodiments, one or more of the inner stator vanes 110 may be a compressor vane. For example, each of the inner stator vanes 110 may be compressor vanes of a compressor. In other embodiments, one or more of the inner stator vanes 110 may be a turbine vane. For instance, each of the inner stator vanes 110 may be turbine vanes of a turbine. Similarly, one or more of the outer stator vanes 112 may be compressor vanes or turbines vanes of a compressor or turbine, respectively. In one particular embodiment, the inner stator vane(s) 110 may be compressor stator vanes, and the outer stator vane(s) 112 may be outlet guide vanes arranged within the by-pass conduit 48.

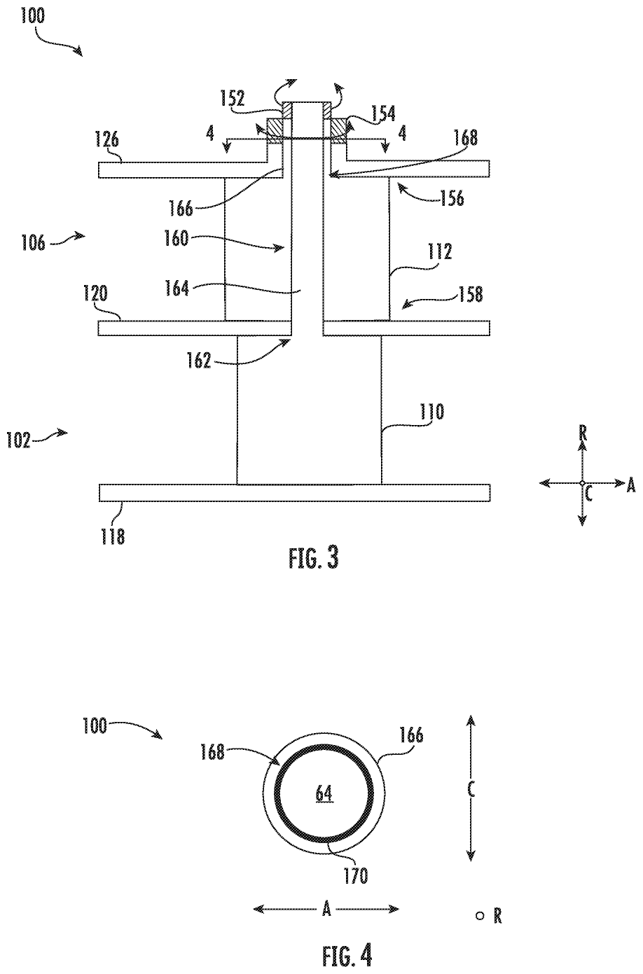

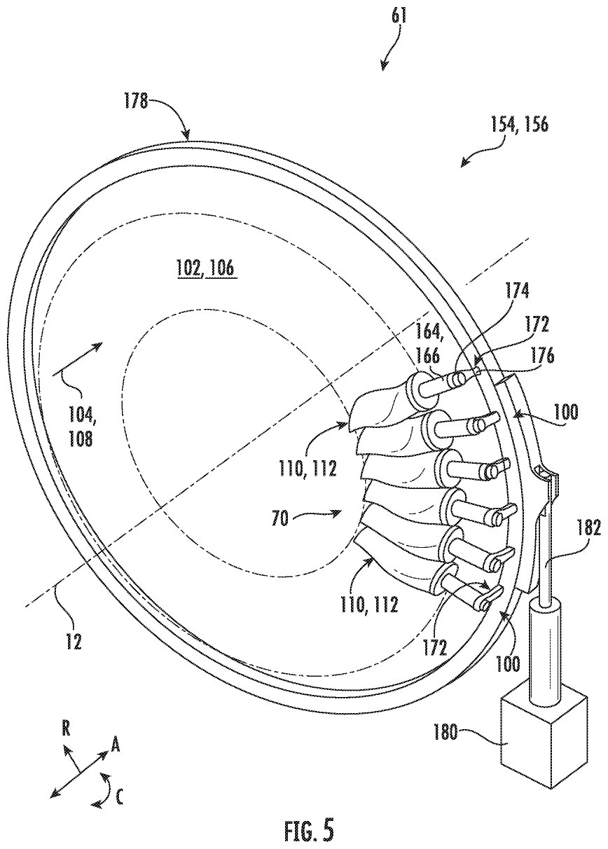

As described briefly above, the rotary component 61 may include one or more actuation assemblies 100 configured to independently alter an orientation of the inner and outer stator vanes 110, 112. For instance, the rotary component 61 may include one actuation assembly 100 for each pair of radially aligned inner and outer stator vanes 110, 112. In another embodiment, each stage 70 of the rotary component 61 may include an actuation assembly 100 configured to alter the orientation of the inner and outer stator vanes 110, 112 within that stage 70. The actuation assembly(ies) 100 may include the inner casing 118 and intermediate casing 120 defining the inner flowpath 102 therebetween. The actuation assembly(ies) 100 may further include the outer casing 126 defining the outer flowpath 106 between the intermediate casing 120 and the outer casing 126. Moreover, the actuation assembly may include the inner stator vane 110 and the outer stator vane 112 positioned within the inner flowpath 102 and the outer flowpath 106, respectively. As described in more detail in regards to FIGS. 3 and 5, the actuation assembly(ies) 100 may include a first rotational device (inner rotational device 152) positioned at or proximate to the outer casing 126. Moreover, the inner rotational device 152 may be configured to alter an orientation of the inner stator vane 110. Additionally, the actuation assembly(ies) 100 may include a second rotational device (outer rotational device 154) positioned at or proximate to the outer casing 126. Similarly, the outer rotational device 154 may be configured to alter an orientation of the outer stator vane 112.

Referring now to FIGS. 3 and 4, multiple schematic views of an embodiment of the actuation assembly 100 are illustrated in accordance with aspects of the present subject matter. More particularly, FIG. 3 illustrates a side view of the actuation assembly 100. FIG. 4 illustrates a cross-section along section line 4-4 of FIG. 3 illustrating trunnions of the actuation assembly 100. It should be appreciated that the actuation assembly 100 may be configured generally as the actuation assembly(ies) of FIG. 2. For instance, the actuation assembly 100 may generally include the inner casing 118, intermediate casing 120, and outer casing 126 defining the inner and outer flowpaths 102, 106. Additionally, the actuation assembly 100 may include the inner stator vane 110 positioned within the inner flowpath 102 and the outer stator vane 112 positioned within the outer flowpath 106.

As shown in FIG. 3, the outer stator vane 112 may extend radially within the outer flowpath 106 between a distal end 156 at the outer casing 126 and a proximate end 158 at the intermediate casing 120. For instance, in certain embodiments, the outer stator vane 112 may be coupled to or formed integrally with both the outer casing 126 and intermediate casing 120. Additionally, the outer stator vane 112 may define a cavity 160 extending between the distal end 156 and the proximate end 158 of the outer stator vane 112. For instance, the cavity 160 may extend generally in the radial direction R. Moreover, as shown, the intermediate casing 120 may define a bore 162 through the intermediate casing 120. For instance, the bore 162 may be radially aligned with the cavity 160 of the outer stator vane 112.

In the illustrated embodiment, the actuation assembly(ies) 100 may include a first trunnion (an inner trunnion 164) drivingly coupled to the inner stator vane 110 such that rotation of the inner trunnion 164 adjusts an orientation of the inner stator vane 110. Additionally, the actuation assembly 100 may include a second trunnion (an outer trunnion 166) drivingly coupled to the outer stator vane 112 such that rotation of the outer trunnion 166 adjusts an orientation of the outer stator vane 112. As shown, the outer trunnion 166 may extend radially inward from the outer casing 126 to the outer stator vane 112. It should be appreciated that the outer trunnion 166 may be coupled to the outer stator vane 112 or be formed integrally with the outer stator vane 112. Additionally, the outer trunnion 166 may extend from the outer casing 126 and terminate at the distal end 156 of the outer stator vane 112. However, in other embodiments, the outer trunnion 166 may extend fully or partially to the proximate end 158 of the outer stator vane 112 through the cavity 160.

As depicted in FIGS. 3 and 4, the outer trunnion 166 may define a bore 168 extending radially through the outer trunnion 166 such that the inner trunnion 164 may extend through the bore 168 of the outer trunnion 166 to the inner stator vane 110. As such, the inner trunnion 164 may be nested within the outer trunnion 166. In certain embodiments, the inner trunnion 164 may extend fully through the bore 168 of an outer trunnion 166 that extends along the full length of the cavity 160 of the outer stator vane 112. However, in other embodiments, the inner trunnion 164 may extend along the length of the bore 168 as well as at least a portion of the cavity 160 (such up to the full length of the cavity 160 between the distal end 156 and the proximate end 158 of the outer stator vane 112). It should be recognized that the inner trunnion 164 may extend through the bore 162 of the intermediate casing 120 (e.g., a bore 162 radially aligned with both the cavity 160 and the bore 168 of the outer trunnion 166) and be drivingly coupled to the inner stator vane 110. Referring particularly to FIG. 4, the actuation assembly 100 may include a bushing 170 within the bore 168 of the outer trunnion 166. More particularly, the bushing 170 may be arranged between the outer trunnion 166 and the inner trunnion 164. Furthermore, the bushing 170 may be coupled to one of the outer trunnion 166 or inner trunnion 164 in order to reduce friction between the trunnions 164, 166 and allow easier relative rotation therebetween. In certain embodiments, the bushing 170 may also extend along the cavity 160 between the inner trunnion 164 and outer stator vane 112. As such, the bushing 170 may be coupled to one of the inner trunnion 164 or the outer stator vane 112 in order to allow easier relative rotation between the inner trunnion 164 and the outer stator vane 112.

Referring particularly to FIG. 3, the actuation assembly 100 may include the inner rotational device 152 at the outer casing 126 drivingly coupled to the inner trunnion 164. Similarly, the outer rotational device 154 at the outer casing 126 may be drivingly coupled to the outer trunnion 166. As such, the rotational devices 152, 154 may allow for the inner trunnion 164 and outer trunnion 166 to be independently rotated in order to adjust the orientation of the inner stator vane 110 and outer stator vane 112 to be independently adjusted.

It should be appreciated that a plurality of the actuation assemblies 100, as illustrated in FIG. 2, may be configured the same or similar to the actuation assembly 100 as depicted in FIGS. 3 and 4. In certain embodiments, each of the actuation assemblies 100 may be configured as the actuation assembly 100 of FIGS. 3 and 4. For example, each of the actuation assemblies 100 may include the inner trunnion 164 drivingly coupled between the inner stator vane 110 and the inner rotational device 152. Further, each actuation assembly 100 may include the outer trunnion 166 drivingly coupled between the outer stator vane 112 and the outer rotational device 154. It should further be appreciated that each of the actuation assemblies 100 may include independent inner and outer rotational devices 152, 154. However, in other embodiments, the actuation assemblies 100 within a stage 70 of the rotary component 61 (FIG. 2) may include one inner rotational device 152 drivingly coupled to each of the inner stator vanes 110 of such stage 70 and one outer rotational device 154 drivingly coupled to each of the outer stator vanes 112 of such stage 70.

Referring now to FIG. 5, one embodiment of a rotational device is illustrated in accordance with aspects of the present disclosure. More particularly, FIG. 5 illustrates a rotational device configured to alter the orientation of multiple stators 110, 112 within a stage 70 of the rotary component 61 (FIG. 2). For instance, one or both of the rotational devices 152, 154 may be configured as the rotational device of FIG. 5. However, it should be appreciated that, in other embodiments, the actuation assembly 100 of each stator vane combination may include independent rotational devices for stator vane 110, 112. It should also be recognized other suitable rotational devices may occur to those of ordinary skill in the art for altering the orientation of the stator vanes 110, 112. For clarity, depicted in FIG. 5 is one rotational device for altering the orientation of the inner stator vanes 110 or the outer stator vanes 112 of a stage 70. However, it should be recognized that each stage 70 may include two rotational devices (e.g., inner rotational device 152 and outer rotational device 154) for rotating the inner and outer stator vanes 110, 112 respectively. For instance, the outer rotational device 154 may be positioned radially inward from the inner rotational device 152 (see, e.g., FIGS. 2 and 3). In additional or alternative embodiments, one rotational device 152, 154 may be positioned axially forward of the stage 70 while the other rotational device 152, 154 may be positioned axially aft of the stage 70.

As shown, each of the rotational devices 152, 154 of the present subject matter generally includes a synchronizing ring 178 configured to actuate a plurality of outwardly extending lever arms 172 mounted onto and rigidly attached to each stator vane 110, 112 (such as via trunnions 164, 166) of a particular stage 70 of the rotary component 61. The synchronizing ring 178 may generally be coupled to the lever arms 172 through a plurality of attachments studs or other suitable fasteners secured along the circumference of the synchronizing ring 178. As shown, each rotational device 154, 156 of the actuation assembly(ies) 100 may include a plurality of lever arms 172 drivingly coupled to the trunnions 164, 166. Further, each lever arm 172 may include a first end 174 rigidly attached to the trunnion 164, 166 drivingly coupled to the variable stator vane 110, 112 and a second end 176 rotatably engaged with and rigidly attached to the synchronizing ring 178, such as via an attachment stud. Generally, the first end 174 of each lever arm 172 may be secured to the trunnion 164, 166 using any suitable means.

Moreover, the synchronizing ring 178 may also be coupled to one or more suitable actuation devices 180 configured to rotate the synchronizing ring 178 about the central axis 12 of the rotary component 61. For example, the synchronizing ring 178 may be coupled to the actuation device(s) 180 via any suitable means (e.g., through a push-rod linkage 182) such that the actuation device(s) 180 rotate the synchronizing ring 178 clockwise or counter-clockwise about the central axis 12. Accordingly, as the synchronizing ring 178 is rotated by the actuation device(s) 180, the lever arms 172 may correspondingly rotate the trunnions 164, 166. The rotating trunnions 164, 166, in turn, cause the stator vanes 110, 112 to rotate, thereby altering the angle at which the vanes 110, 112 are oriented relative to the inner fluid flow 104, 108 within the rotary component 61.

In general, the synchronizing ring 178 of the rotational device 152, 154 may comprise a circular or ring-like structure disposed radially outwardly from and substantially concentric with the outer casing 126 (see, e.g., FIGS. 2 and 3). In several embodiments, the synchronizing ring 178 may be manufactured as a one-piece or multiple-piece construction and may be formed from any suitable material, such as a stainless steel or any other material capable of withstanding the loads typically applied to a synchronizing ring. Additionally, the synchronizing ring 178 may generally have any suitable cross-section, such as a rectangular, elliptical or circular cross-section. As particularly shown in the depicted embodiment, the synchronizing ring 178 may define a generally “C-shaped” cross-section. As such, the synchronizing ring 178 may be configured to be relatively lightweight without sacrificing the structural integrity of the ring synchronizing 178.

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

1. An actuation assembly for concentric variable stator vanes of a rotary component of a gas turbine engine defining a central axis extending along an axial direction, the actuation assembly comprising an inner casing; an intermediate casing, wherein the inner casing and the intermediate casing define a first concentric flowpath between the inner casing and the intermediate casing, the first concentric flowpath extending along the axial direction; an outer casing, wherein the intermediate casing and the outer casing define a second concentric flowpath between the intermediate casing and the outer casing, the second concentric flowpath extending along the axial direction and positioned radially exterior to the first concentric flowpath; a first variable stator vane extending radially inward from the intermediate casing into the first concentric flowpath; a second variable stator vane extending radially within the second concentric flowpath between a distal end at the outer casing and proximate end at the inner casing, the second variable stator vane defining a cavity extending between the distal end and the proximate end; and a first trunnion extending radially inward from the outer casing through the cavity of the second variable stator vane and drivingly coupled to the first variable stator vane.

2. The actuation assembly of any preceding clause, wherein an orientation of the first variable stator vane and an orientation of the second variable stator vane are independently adjustable.

3. The actuation assembly of any preceding clause, wherein the first and second variable stator vanes are radially aligned.

4. The actuation assembly of any preceding clause, further comprising a first rotational device positioned at the outer casing and drivingly coupled to the first trunnion such that rotation of the first rotational device alters an orientation of the first variable stator vane.

5. The actuation assembly of any preceding clause, further comprising a second trunnion extending radially inward from the outer casing and drivingly coupled to the second variable stator vane, the second trunnion defining a bore extending radially through the second trunnion such that the first trunnion extends through the bore of the second trunnion to the first variable stator vane.

6. The actuation assembly of any preceding clause, further comprising a bushing positioned between the first trunnion and the second trunnion.

7. The actuation assembly of any preceding clause, further comprising a second rotational device positioned at the outer casing and drivingly coupled to the second trunnion such that rotation of the second rotational device alters an orientation of the second variable stator vane.

8. The actuation assembly of any preceding clause, wherein the first and second variable stator vanes each define an aerodynamic profile including a leading edge, trailing edge, pressure side, and suction side.

9. The actuation assembly of any preceding clause, where at least one of the first variable stator vane or the second variable stator vane is a compressor vane.

10. The actuation assembly of any preceding clause, wherein at least one of the first variable stator vane or the second variable stator vane is a turbine vane.

11. The actuation assembly of any preceding clause, wherein at least one of the first variable stator vane or the second variable stator vane is configured to act as a valve.

12. A rotary component for a gas turbine engine defining a central axis extending along an axial direction, the rotary component comprising an inner casing; an intermediate casing, wherein the inner casing and the intermediate casing define a first concentric flowpath between the inner casing and the intermediate casing, the first concentric flowpath extending along the axial direction; an outer casing, wherein the intermediate casing and the outer casing define a second concentric flowpath between the intermediate casing and the outer casing, the second concentric flowpath extending along the axial direction and positioned radially exterior to the first concentric flowpath; a plurality of rotor blades circumferentially oriented within the first concentric flowpath and drivingly coupled to a rotor extending along the central axis, the plurality of rotor blades extending radially outward from the rotor to the intermediate casing within the first concentric flowpath; a plurality of first variable stator vanes circumferentially oriented within the first concentric flowpath and extending radially inward from the intermediate casing into the first concentric flowpath, wherein the plurality of rotor blades and the plurality of first variable stator vanes form a stage of the rotary component; a plurality of second variable stator vanes circumferentially oriented within the second concentric flowpath, each of the second variable stator vanes extending radially within the second concentric flowpath between a distal end at the outer casing and proximate end at the intermediate casing and defining a cavity extending between the distal end and the proximate end; and a plurality of first trunnions, each of the first trunnions extending radially inward from the outer casing through the cavity of one of the plurality of second variable stator vanes and drivingly coupled to one of the plurality of first variable stator vanes.

13. The rotary component of any preceding clause, wherein an orientation of the plurality of first variable stator vanes and an orientation of the plurality of second variable stator vanes are independently adjustable.

14. The rotary component of any preceding clause, wherein each of the plurality of first variable stator vanes is radially aligned with one of the plurality of second variable stator vanes.

15. The rotary component of any preceding clause, further comprising a plurality of second trunnions, each of the second trunnions extending radially inward from the outer casing and drivingly coupled to one of the plurality of the second variable stator vanes, each of the second trunnions defining a bore extending radially through the second trunnion such that one of the first trunnions extends through the bore of each the second trunnions to one of the first variable stator vanes.

16. The rotary component of any preceding clause, further comprising a plurality of bushings, each of the plurality of bushings positioned between one of the first trunnions and one of the second trunnions.

17. The rotary component of any preceding clause, further comprising at least one first rotational device positioned at the outer casing and drivingly coupled to each of the first trunnions such that rotation of the at least one first rotational device alters an orientation of each of the first variable stator vanes; and at least one second rotational device positioned at the outer casing and drivingly coupled to each of the second trunnions such that rotation of the at least one second rotational device alters an orientation of each of the second variable stator vanes.

18. The rotary component of any preceding clause, wherein the rotary component is a compressor, and wherein each of the plurality of rotor blades is a compressor blade and each of the plurality of first variable stator vanes is a compressor vane.

19. The rotary component of any preceding clause, wherein the rotary component is a turbine, and wherein each of the plurality of rotor blades is a turbine blade and each of the plurality of first variable stator vanes is a turbine vane.

20. The rotary component of any preceding clause, wherein each of the plurality of rotor blades extends radially outward from the rotor to the outer casing and includes a platform separating the first concentric flowpath from the second concentric flowpath, and wherein each of the rotor blades includes a first airfoil portion within the first concentric flowpath and a second airfoil portion within the second concentric flowpath.

21. The rotary component of any preceding clause, wherein at least one stator vane of the plurality of first variable stator vanes or the plurality of second variable stator vane is configured to act as a valve.

What is claimed is:

1. An actuation assembly for concentric variable stator vanes of a rotary component of a gas turbine engine defining a central axis extending along an axial direction, the actuation assembly comprising:
an inner casing;
an intermediate casing, wherein the inner casing and the intermediate casing define a first concentric flowpath between the inner casing and the intermediate casing, the first concentric flowpath extending along the axial direction;
an outer casing, wherein the intermediate casing and the outer casing define a second concentric flowpath between the intermediate casing and the outer casing, the second concentric flowpath extending along the axial direction and positioned radially exterior to the first concentric flowpath;
a first variable stator vane extending radially inward from the intermediate casing into the first concentric flowpath;
a second variable stator vane extending radially within the second concentric flowpath between a distal end at the outer casing and proximate end at the inner casing, the second variable stator vane defining a cavity extending between the distal end and the proximate end; and
a first trunnion extending radially inward from the outer casing through the cavity of the second variable stator vane and drivingly coupled to the first variable stator vane.

2. The actuation assembly of claim 1, wherein an orientation of the first variable stator vane and an orientation of the second variable stator vane are independently adjustable.

3. The actuation assembly of claim 1, wherein the first and second variable stator vanes are radially aligned.

4. The actuation assembly of claim 1, further comprising:
a first rotational device positioned at the outer casing and drivingly coupled to the first trunnion such that rotation of the first rotational device alters an orientation of the first variable stator vane.

5. The actuation assembly of claim 1, further comprising:
a second trunnion extending radially inward from the outer casing and drivingly coupled to the second variable stator vane, the second trunnion defining a bore extending radially through the second trunnion such that the first trunnion extends through the bore of the second trunnion to the first variable stator vane.

6. The actuation assembly of claim 5, further comprising:
a bushing positioned between the first trunnion and the second trunnion.

7. The actuation assembly of claim 5, further comprising:
a second rotational device positioned at the outer casing and drivingly coupled to the second trunnion such that rotation of the second rotational device alters an orientation of the second variable stator vane.

8. The actuation assembly of claim 1, wherein the first and second variable stator vanes each define an aerodynamic profile including a leading edge, trailing edge, pressure side, and suction side.

9. The actuation assembly of claim 1, where at least one of the first variable stator vane or the second variable stator vane is a compressor vane.

10. The actuation assembly of claim 1, wherein at least one of the first variable stator vane or the second variable stator vane is a turbine vane.

11. The actuation assembly of claim 1, wherein at least one of the first variable stator vane or the second variable stator vane is configured to act as a valve.

12. A rotary component for a gas turbine engine defining a central axis extending along an axial direction, the rotary component comprising:
an inner casing;
an intermediate casing, wherein the inner casing and the intermediate casing define a first concentric flowpath between the inner casing and the intermediate casing, the first concentric flowpath extending along the axial direction;
an outer casing, wherein the intermediate casing and the outer casing define a second concentric flowpath between the intermediate casing and the outer casing, the second concentric flowpath extending along the axial direction and positioned radially exterior to the first concentric flowpath;
a plurality of rotor blades circumferentially oriented within the first concentric flowpath and drivingly coupled to a rotor extending along the central axis, the plurality of rotor blades extending radially outward from the rotor to the intermediate casing within the first concentric flowpath;
a plurality of first variable stator vanes circumferentially oriented within the first concentric flowpath and extending radially inward from the intermediate casing into the first concentric flowpath, wherein the plurality of rotor blades and the plurality of first variable stator vanes form a stage of the rotary component;
a plurality of second variable stator vanes circumferentially oriented within the second concentric flowpath, each of the second variable stator vanes extending radially within the second concentric flowpath between a distal end at the outer casing and proximate end at the intermediate casing and defining a cavity extending between the distal end and the proximate end; and
a plurality of first trunnions, each of the first trunnions extending radially inward from the outer casing through the cavity of one of the plurality of second variable stator vanes and drivingly coupled to one of the plurality of first variable stator vanes.

13. The rotary component of claim 12, wherein an orientation of the plurality of first variable stator vanes and an orientation of the plurality of second variable stator vanes are independently adjustable.

14. The rotary component of claim 12, wherein each of the plurality of first variable stator vanes is radially aligned with one of the plurality of second variable stator vanes.

15. The rotary component of claim 12, further comprising:
a plurality of second trunnions, each of the second trunnions extending radially inward from the outer casing and drivingly coupled to one of the plurality of the second variable stator vanes, each of the second trunnions defining a bore extending radially through the second trunnion such that one of the first trunnions extends through the bore of each the second trunnions to one of the first variable stator vanes.

16. The rotary component of claim 15, further comprising:
a plurality of bushings, each of the plurality of bushings positioned between one of the first trunnions and one of the second trunnions.

17. The rotary component of claim 15, further comprising:
at least one first rotational device positioned at the outer casing and drivingly coupled to each of the first trunnions such that rotation of the at least one first rotational device alters an orientation of each of the first variable stator vanes; and
at least one second rotational device positioned at the outer casing and drivingly coupled to each of the second trunnions such that rotation of the at least one second rotational device alters an orientation of each of the second variable stator vanes.

18. The rotary component of claim 12, wherein the rotary component is a compressor, and wherein each of the plurality of rotor blades is a compressor blade and each of the plurality of first variable stator vanes is a compressor vane.

19. The rotary component of claim 12, wherein the rotary component is a turbine, and wherein each of the plurality of rotor blades is a turbine blade and each of the plurality of first variable stator vanes is a turbine vane.

20. The rotary component of claim 12, wherein each of the plurality of rotor blades extends radially outward from the rotor to the outer casing and includes a platform separating the first concentric flowpath from the second concentric flowpath, and wherein each of the rotor blades includes a first airfoil portion within the first concentric flowpath and a second airfoil portion within the second concentric flowpath.
